(19) United States
(12) Patent Application Publication
(10) Pub. No.: US 2021/0390452 A1
(43) Pub. Date: Dec. 16, 2021

(54) MACHINE-LEARNING DEVICE, MACHINE-LEARNING METHOD, DATA GENERATION DEVICE, DATA GENERATION METHOD, AND NON-TRANSITORY COMPUTER-READABLE STORAGE MEDIUM FOR PROGRAM

(71) Applicant: FUJITSU LIMITED, Kawasaki-shi (JP)

(72) Inventors: Shun KOHATA, Setagaya (JP); Shohei YAMANE, Kawasaki (JP); Takashi YAMAZAKI, Kawasaki (JP); Fumiyasu MAKINOSHIMA, Kawasaki (JP); Yusuke OISHI, Yokohama (JP)

(73) Assignee: FUJITSU LIMITED, Kawasaki-shi (JP)

(21) Appl. No.: 17/337,456

(22) Filed: Jun. 3, 2021

(30) Foreign Application Priority Data
Jun. 15, 2020 (JP) 2020-103133

(51) Int. Cl. G06N 20/00; G06N 5/04; G06F 30/28

(52) U.S. Cl. CPC G06N 20/00; G06F 2111/10; G06F 30/28; G06N 5/04

(57) ABSTRACT

A machine learning method implemented by a computer includes: acquiring simulation conditions including a shape of an object and an inflow velocity of fluid; identifying, based on the shape of the object and the inflow velocity that have been acquired, a position of a boundary layer with respect to the object, a diffusion range of the fluid, and a flow velocity diffusion range of a wake flow of the fluid; creating training data associating the position of the boundary layer, the diffusion range of the fluid, and the flow velocity diffusion range of the wake flow of the fluid that have been identified with a flow velocity field under the simulation conditions; and generating a model that estimates the flow velocity field from the simulation conditions by using the training data.

### CROSS-REFERENCE TO RELATED APPLICATION

This application is based upon and claims the benefit of priority of the prior Japanese Patent Application No. 2020-103133, filed on Jun. 15, 2020, the entire contents of which are incorporated herein by reference.

### FIELD

The embodiments discussed herein are related to a non-transitory computer-readable storage medium storing a machine-learning program, a machine-learning device, a machine-learning method, a non-transitory computer-readable storage medium storing a flow velocity field estimation program, a data generation device, and a data generation method.

### BACKGROUND

In the manufacturing industry, computer aided engineering (CAE) for performing virtual design trial production by simulation is widely used for the purpose of reducing rework in development and testing phase.

For example, in mobile objects and transportation equipment such as automobiles and aircrafts, resistance and lift during movement of a mobile object or the like are important factors for product quality. Thus, aerodynamic analysis is performed in the upstream process of designing mobile objects or the like.

The aerodynamic analysis reproduces and analyzes the flow velocity field of fluid around an object by simulation based on viscous fluid dynamics.

In a conventional aerodynamic analysis method, for example, shape characteristics of a target object are modeled by a signed distance function (SDF), and the flow velocity field is estimated based on a modeled object shape.

To estimate the flow velocity field by the conventional aerodynamic analysis method, a model with the SDF shape as input and the flow velocity field around the object as output is constructed by deep learning (artificial intelligence (AI)).

Note that the aerodynamic simulation is executed only when the model is constructed, and simulation data in various shapes is learned. Two-dimensional SDF shape data is used as an explanatory variable, and multivariable nonlinear regression based on two-dimensional flow velocity field data is used as an objective variable.

Examples of the related art include Japanese Laid-open Patent Publication No. 2012-216173 and Japanese Laid-open Patent Publication No. 2019-125102.

### SUMMARY

According to an aspect of the embodiments, a machine learning method implemented by a computer includes: acquiring simulation conditions including a shape of an object and an inflow velocity of fluid; identifying, based on the shape of the object and the inflow velocity that have been acquired, a position of a boundary layer with respect to the object, a diffusion range of the fluid, and a flow velocity diffusion range of a wake flow of the fluid; creating training data associating the position of the boundary layer, the diffusion range of the fluid, and the flow velocity diffusion range of the wake flow of the fluid that have been identified with a flow velocity field under the simulation conditions; and generating a model that estimates the flow velocity field from the simulation conditions by using the training data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a functional configuration of a simulation apparatus as one example of an embodiment;

FIG. 2 is a diagram illustrating a simulation space used for aerodynamic simulation by the simulation apparatus as one example of the embodiment;

FIG. 3 is a diagram for explaining a boundary layer angle in the simulation space;

FIG. 4 is a diagram for explaining a thickness of velocity diffusion in the simulation space;

FIG. 5 is a diagram for explaining a wake flow point in the simulation space;

FIG. 6 is a diagram for explaining a method for setting a simple flow velocity field by a simple flow velocity field setting unit in the simulation apparatus as one example of the embodiment;

FIG. 7 is a diagram for explaining a method for setting the simple flow velocity field by the simple flow velocity field setting unit in the simulation apparatus as one example of the embodiment;

FIG. 8 is a diagram for explaining a method for setting the simple flow velocity field by the simple flow velocity field setting unit in the simulation apparatus as one example of the embodiment;

FIG. 9 is a diagram for explaining a method for setting the simple flow velocity field by the simple flow velocity field setting unit in the simulation apparatus as one example of the embodiment;

FIG. 10 is a diagram illustrating the simple flow velocity field in the simulation apparatus as one example of the embodiment;

FIG. 11 is a flowchart for explaining a model construction process of the simple flow velocity field in the simulation apparatus as one example of the embodiment;

FIG. 12 is a flowchart for explaining a creation process of a learning model by a learning processing unit in the simulation apparatus as one example of the embodiment;

FIG. 13 is a flowchart for explaining a verification process of the learning model by an evaluation unit in the simulation apparatus as one example of the embodiment;

FIG. 14 is a diagram illustrating a predicted flow velocity field by the simulation apparatus as one example of the embodiment together with a correct flow velocity field and a predicted flow velocity field by a conventional aerodynamic analysis method;

FIG. 15 is a diagram illustrating a comparison of accuracy evaluation indexes between the predicted flow velocity field by the simulation apparatus as one example of the embodiment and the predicted flow velocity field by the conventional aerodynamic analysis method;

FIG. 16 is a diagram for explaining a difference in the predicted flow velocity field for an object having a different shape on a leeward side between the conventional aerodynamic analysis method and this simulation apparatus;

FIG. 17 is a diagram for explaining a difference in the predicted flow velocity field for an object having a different shape on the leeward side between the conventional aerodynamic analysis method and this simulation apparatus;

FIG. 18 is a diagram illustrating a hardware configuration of a simulation apparatus as one example of the embodiment;

FIG. 19 is a diagram for explaining model accuracy related to a model of a thickness of diffusion; and

FIG. 20 is a diagram illustrating machine learning for outputting flow velocity field data by using an SDF shape and a Reynolds number as input data.

### DESCRIPTION OF EMBODIMENTS

However, in such a conventional aerodynamic analysis method, the SDF shape does not include information on an inflow velocity of the fluid. Therefore, it is not possible to model a case in which the inflow velocity of the fluid is variable, and there is a problem that a plurality of pieces of flow velocity field data is generated for the same SDF shape and learning accuracy decreases.

In one aspect, it is an object of the embodiments to enable aerodynamic analysis with a variable fluid inflow velocity.

In order to make an inflow velocity variable when estimating a flow velocity field based on an object shape, it is conceivable to add information of Reynolds number to an object shape.

For example, the flow velocity field that reflects shape information and flow velocity information is estimated by calculating the product of an SDF and a Reynolds number.

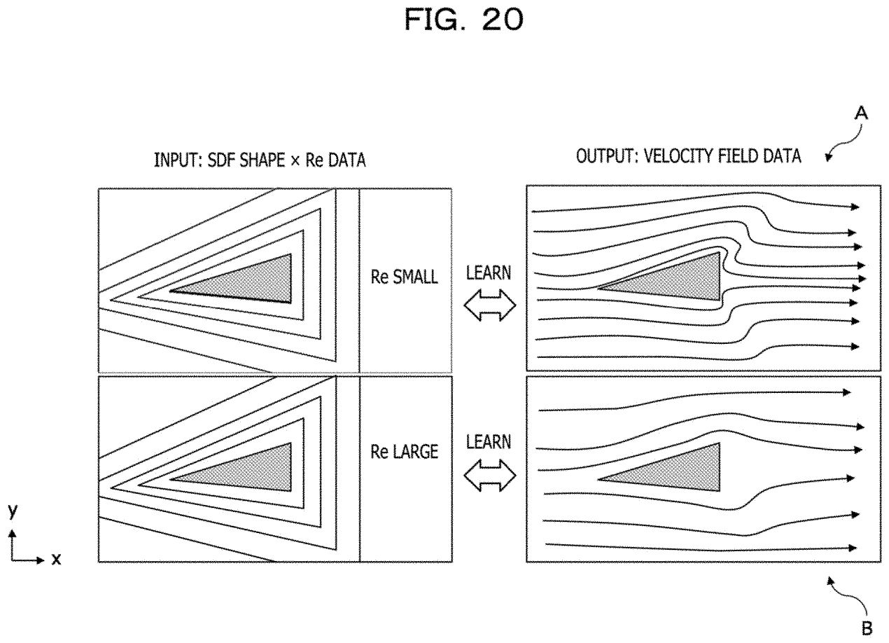

FIG. 20 is a diagram illustrating machine learning for outputting flow velocity field data by using an SDF shape and a Reynolds number as input data. In FIG. 20, a reference sign A indicates a flow velocity field data output when the Reynolds number (Re) is small, and a reference sign B indicates a flow velocity field when the Reynolds number is large.

Note that the inflow velocity, viscosity coefficient, and fluid density needed for calculating the Reynolds number may be obtained from simulation information given in advance. The estimation of the flow velocity field is performed by utilizing that a viscous fluid equation is characterized by the Reynolds number.

Here, behavior of fluid in the flow velocity field depends on the inflow velocity and the object shape on the upstream side in a flow direction of the fluid. Therefore, the flow velocity field has a similarity between objects having inflow velocities close to each other and having upstream-side shapes similar to each other.

However, since the conventional aerodynamic analysis method uniformly learns information of the entire shape of an object, even those with similar flow velocity fields are learned and predicted as completely different data. It may suffice if it is possible to comprehensively prepare learning data for all shapes and inflow velocities, but it is unrealistic because calculation cost of aerodynamic simulation is high.

Consequently, flow velocity field characteristics for every shape may not be appropriately reflected on input data, and estimation accuracy of the learning model decreases. Accordingly, there is a need to create input data considering characteristics (fluid characteristics) of the upstream side and the downstream side of the fluid.

Hereinafter, embodiments related to a present machine learning program, machine learning device, machine learning method, flow velocity field estimation program, data generation device, and data generation method will be described with reference to the drawings. However, the embodiments to be described below are merely examples, and there is no intention to exclude application of various modifications and techniques not explicitly described in the embodiments. For example, the present embodiments may be modified in various ways to be implemented without departing from the spirit of the embodiments. Furthermore, each drawing is not intended to include only components illustrated in the drawing and may include other functions and the like.

(A) Configuration

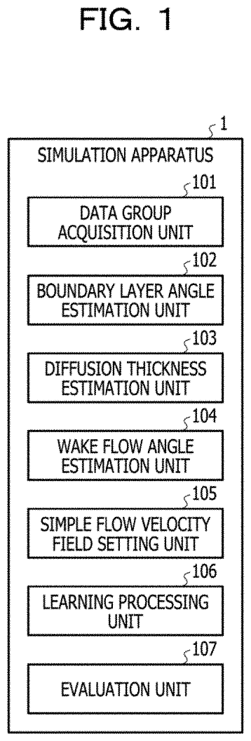

FIG. 1 is a diagram schematically illustrating a functional configuration of a simulation apparatus 1 as one example of an embodiment.

The simulation apparatus 1 simulates a flow velocity field around an object based on the shape of the object and simulation conditions including an inflow velocity of fluid. The flow velocity field may be called a velocity field. Hereinafter, an example in which the fluid is gas (air) is illustrated, and the simulation apparatus 1 performs an aerodynamic simulation.

As illustrated in FIG. 1, the simulation apparatus 1 includes functions as a data group acquisition unit 101, a boundary layer angle estimation unit 102, a diffusion thickness estimation unit 103, a wake flow angle estimation unit 104, a simple flow velocity field setting unit 105, a learning processing unit 106, and an evaluation unit 107.

—Data Group Acquisition Unit 101—

The data group acquisition unit 101 acquires various data (data groups) used for performing the aerodynamic simulation. The data used for performing the aerodynamic simulation may be referred to as aerodynamic simulation data.

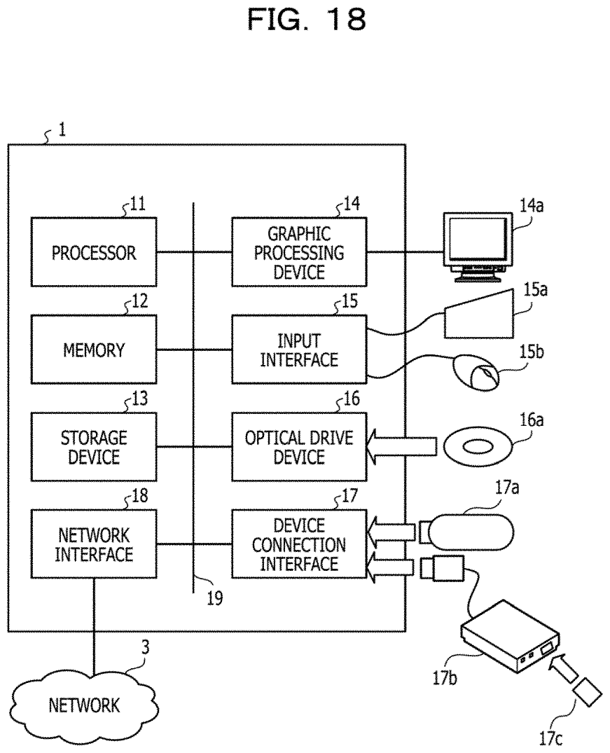

The data group acquisition unit 101 acquires, for example, shape data of an object as a target of simulation. The shape data may be created by, for example, a modeling tool that is not illustrated or may be managed as design data. The data group acquisition unit 101 may acquire the shape data by reading shape data stored in a storage device 13 (see FIG. 18) or various storage media, for example. Furthermore, the data group acquisition unit 101 may receive shape data from another information processing device connected via a network that is not illustrated, and may be appropriately modified and implemented.

Furthermore, the shape data in the data group also includes the orientation of the object with respect to the fluid. Moreover, the data group also includes simulation conditions including the Reynolds number and the inflow velocity of fluid.

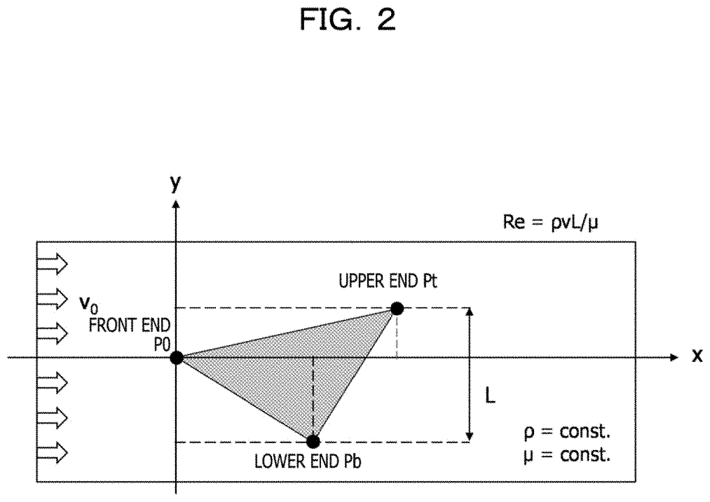

FIG. 2 is a diagram illustrating a simulation space used for the aerodynamic simulation by the simulation apparatus 1 as one example of the embodiment.

FIG. 2 illustrates a two-dimensional simulation space configured as an orthogonal coordinate system having an x-axis and a y-axis. An object is placed in such a simulation space, and fluid having a uniform velocity v0 is made to flow from a boundary (left-side boundary) of one side (left side in the present embodiment) toward the other side (right side in the present embodiment). For example, it is assumed that the inflow velocity of the fluid is v0.

Hereinafter, in the simulation space illustrated in FIG. 2 and the like, it is assumed that the upstream side (left side in the diagram) of a flow direction of the fluid is a negative side in an x-axis direction, and the downstream side of the flow direction (right side in the diagram) is a positive side in the x-axis direction. Furthermore, hereinafter, a length in a y-axis direction may be referred to as a height in the simulation space.

In the simulation space, the shape of the object is represented by a triangle having a front end P0, an upper end Pt, and a lower end Pb as respective vertices, and the data group acquisition unit 101 acquires respective coordinates of these front end P0, upper end Pt, and lower end Pb. The shape of the object on the upstream side is specified by these front end P0, upper end Pt and lower end Pb. The direction of an angle formed by connecting the front end P0 and the upper end Pt and the front end P0 and the lower end Pb, for example, the direction in which the front end P0 projects represents the direction of the object.

The data group acquisition unit 101 may calculate the respective coordinates of these front end P0, upper end Pt, and lower end Pb based on, for example, design data of the object.

Although the object is designed as three-dimensional, its cross-sectional shape is arranged for convenience in the simulation space illustrated in FIG. 2 and the like. For example, the object actually extends along a direction orthogonal to an x-y plane (paper depth direction) in the simulation space illustrated in FIG. 2, but hereinafter, the object is treated as a two-dimensional figure arranged on the x-y plane.

The data group acquisition unit 101 calculates, for example, the respective coordinates of the upper end Pt and the lower end Pb with the front end P0 of the object as the origin. It is assumed that the coordinates of the upper end Pt are (xt, yt) and the coordinates of the lower end Pb are (xb, yb).

Furthermore, the data group acquisition unit 101 calculates a Reynolds number Re. The Reynolds number Re may be obtained, for example, by using equation (1) below with a maximum length of the object in a vertical component in the inflow direction as a typical length L (see FIG. 2).

Re=ρvL/μ (1)

In equation (1), p represents density of the fluid, v represents a relative average velocity (m/s) with respect to a flow of the object, L represents a characteristic length, and p represents a viscosity coefficient of the fluid.

The data group acquisition unit 101 stores acquired aerodynamic simulation data and each calculated value in a predetermined storage area of a memory 12 or the storage device 13 (see FIG. 18).

Boundary Layer Angle Estimation Unit 102—

The velocity of fluid near the object decreases due to viscosity, which forms a boundary layer on a surface of the object that has a velocity equal to the inflow velocity. Hereinafter, the surface of this boundary layer may be referred to as a boundary layer surface. A space sandwiched between the surface of the object and the boundary layer surface may be referred to as a boundary layer.

The boundary layer angle estimation unit 102 estimates a boundary layer angle ψ.

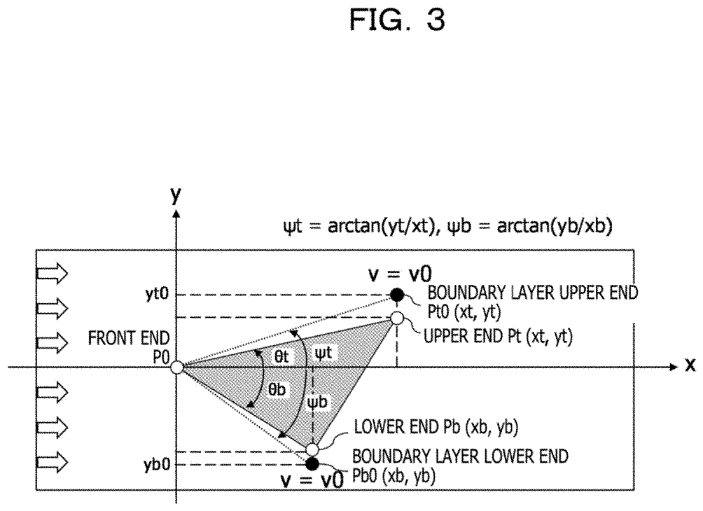

FIG. 3 is a diagram for explaining the boundary layer angle ψ in the simulation space.

In the simulation space illustrated in FIG. 3, a line connecting the front end P0 and the upper end Pt of the object is called an upper side, and a line connecting the front end P0 and the lower end Pb of the object is called a lower side.

An angle θt formed by the upper side of the object and the x-axis and an angle θb formed by the lower side of the object and the x-axis are each called an object angle. The object angle may be called a shape angle. The object angles θt, θb may be expressed by equation (2) below.

$$\begin{matrix}Object angle θ t = arctan ( yt \text{/} xt ) \\ Object angle θ b = arctan ( yb \text{/} xb )\end{matrix} \} \qquad ( 2 )$$

Hereinafter, when the object angles θt, θb are not particularly distinguished, they will be referred to as an object angle θ.

When there is an object angle θ (θ>0), it is not possible to uniquely define the position of the boundary layer, but for the purpose of simply considering fluid characteristics, the position of the boundary layer may be defined as a point where v=v0. The boundary layer angle estimation unit 102 calculates y-coordinates yt0, yb0 at which v=v0 at each position of xt, xb on the x-coordinates, respectively. For example, the boundary layer angle estimation unit 102 calculates a position Pt0 (xt, yt0) on the boundary layer surface above the upper side and a position Pb0 (xb, yb0) on the boundary layer surface below the lower side. The position Pt0 (xt, yt0) may be called a boundary layer upper end Pt0. Furthermore, the position Pb0 (xb, yb0) may be referred to as a boundary layer lower end Pb0. Furthermore, the coordinates (xt, yt0) of the boundary layer upper end Pt0 and the coordinates (xb, yb0) of the boundary layer lower end Pb0 may each be referred to as a boundary layer surface coordinate.

An angle ψt formed by a line connecting the front end P0 of the object and the boundary layer upper end Pt0 and the x-axis, and an angle ψb formed by a line connecting the front end P0 of the object and the boundary layer lower end Pb0 and the x-axis, are each referred to as a boundary layer angle.

The line connecting the front end P0 of the object and the boundary layer upper end Pt0 corresponds to the boundary layer surface above the object, and the line connecting the front end P0 of the object and the boundary layer lower end Pb0 corresponds to the boundary layer surface below the object.

The boundary layer angle estimation unit 102 calculates the boundary layer angles ψt, ψb using equation (3) below.

$$\begin{matrix}Boundary layer angle ϕ t = arctan ( yt \text{/} xt ) \\ Boundary layer angle ϕ b = arctan ( yb \text{/} xb )\end{matrix} \} \qquad ( 3 )$$

Hereinafter, when the boundary layer angles ψt, ψb are not particularly distinguished, they will be referred to as a boundary layer angle ψ.

The boundary layer angle ψ is an angle formed by a straight line (boundary layer surface), which connects the object front end P0 and a point where the flow velocity coincides with an initial velocity (boundary layer upper end Pt0, boundary layer lower end Pb0), and a reference axis (x axis) when the front end P0 of the object is the origin of a height (length in the y-axis direction).

The boundary layer angle estimation unit 102 statistically models the boundary layer angle ψ based on information obtained from a simulation data group.

Here, a thickness δ of the boundary layer on a flat plate (object angle θ=0) is obtained by equation (4) below.

δ/x∝1/\sqrt{Re} (4)

By introducing the object angle θ to this equation (4), equation (5) below may be obtained.

δ/x=tan(ϕ·θ)=C(θ)/\sqrt{Re} (4)

Here, C(θ) is any function and, for example, an exponential function C(θ)=aθ is applied (a is a constant).

The boundary layer angle estimation unit 102 defines a regression model represented by equation (6) below.

ln\sqrt{Re} tan(ψ−θ)=aθ (6)

By modeling ψ using the estimation parameter \hat{α} from the regression model described above, equation (7) below can be obtained.

$$ψ ( θ ; Re ) = arctan ( \frac{exp \hat{a} θ}{\sqrt{Re}} ) + θ \qquad ( 7 )$$

As the object angle θ increases, the inflow energy increases, and thus the thickness of the boundary layer decreases. In this simulation apparatus 1, as illustrated in equation (7) above, a model for estimating the boundary layer angle ψ based on the Reynolds number Re and the object angle θ is constructed.

—Diffusion Thickness Estimation Unit 103—

The diffusion thickness estimation unit 103 constructs a model that estimates a thickness l of velocity diffusion in the simulation space based on the Reynolds number Re and the object angle θ.

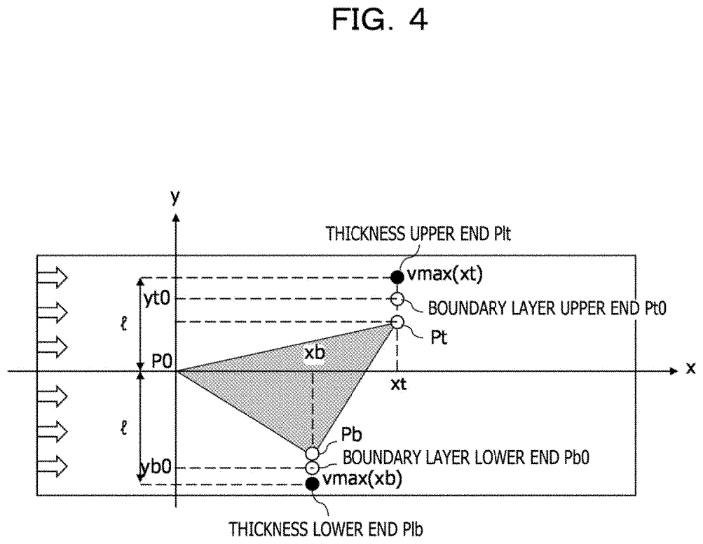

FIG. 4 is a diagram for explaining a thickness of velocity diffusion in the simulation space.

The diffusion thickness estimation unit 103 identifies a point where v=vmax for each of the x-coordinates xt, xb. Hereinafter, the point where v=vmax at x=xt is called a thickness upper end and is represented by a reference sign Plt. The point where v=vmax at x=xb is called a thickness lower end and is represented by a reference sign Plb. The diffusion thickness estimation unit 103 calculates y-coordinate values (thickness l of velocity diffusion) of these thickness upper end Plt and thickness lower end.

The thickness l of velocity diffusion is a height component at a position where the flow velocity is the maximum and represents the diffusion range of the fluid, the height component being calculated based on the Reynolds number Re and the object angle θ.

The fluid is gradually swept up while passing around the object, reaching the maximum velocity at these thickness upper end Plt and thickness lower end Plb. The maximum velocity may be reproduced by the fluid at the front end diffusing with the thickness l.

The diffusion thickness estimation unit 103 statistically models the thickness l of diffusion based on the information obtained from the simulation data group. The thickness l of diffusion is related to the object angle θ and the Reynolds number Re. Therefore, in this simulation apparatus 1, equation (8) below is defined as a regression model of the thickness l of diffusion.

[symbol]

=aRe+bθ+c (8)

The diffusion thickness estimation unit 103 models the thickness l of velocity diffusion from the regression model described above by using estimation parameters a, b, c.

—Wake Flow Angle Estimation Unit 104—

The wake flow angle estimation unit 104 calculates the coordinates of a point (wake flow point) Ps where v=zero on the most leeward side of the object.

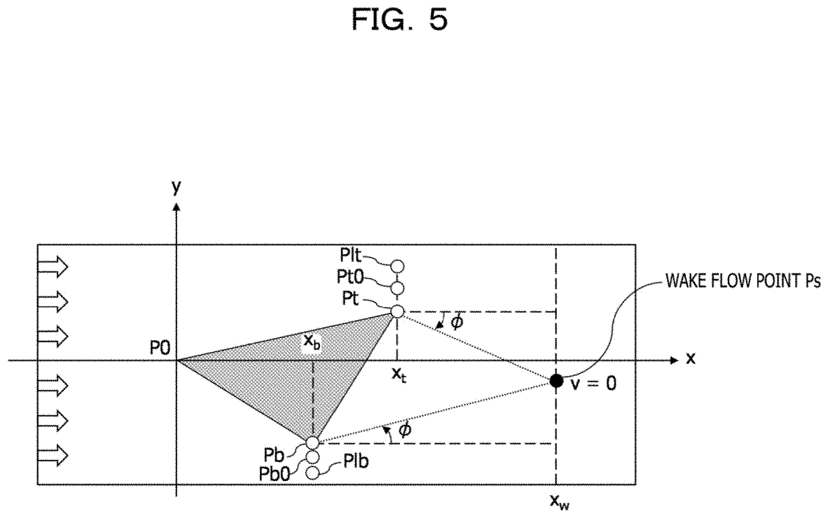

FIG. 5 is a diagram for explaining a wake flow point in the simulation space.

The wake flow indicates a vortex region leeward of the object, which is difficult to formulate, but for the purpose of simply considering the fluid characteristics, the point where v=0 may be defined as a typical length of the wake flow.

The wake flow angle estimation unit 104 calculates, at each of the upper end Pt and the lower end Pb of the object, an angle (wake flow angle) φ formed by a horizontal plane and a line connecting to the wake flow point.

The wake flow angle φ is the angle of flow velocity diffusion of the wake flow, and represents a flow velocity diffusion range of the wake flow of the fluid. The wake flow angle estimation unit 104 statistically models the wake flow angle φ based on the information obtained from the simulation data group. For example, the wake flow angle estimation unit 104 constructs a model that estimates the wake flow angle φ based on the Reynolds number Re.

The length from the object to the wake flow point has a correlation with the Reynolds number Re. Therefore, in this simulation apparatus 1, the regression model xw=aRe+b is defined. Furthermore, xw may be expressed by equation (9) below.

$${x}_{w} = \frac{( {y}_{t} + {y}_{b} ) + ( {x}_{l} + {x}_{b} ) tan ϕ}{2 tan ϕ} \qquad ( 9 )$$

The wake flow angle estimation unit 104 models the wake flow angle φ as illustrated in equation (10) below by using the estimation parameters a, b and xw from the regression model xw=aRe+b described above.

$$ϕ = arctan [ \frac{( {y}_{t} + {y}_{b} )}{2 ( a Re + b ) - ( {x}_{l} + {x}_{b} )} ] \qquad ( 10 )$$

—Simple Flow Velocity Field Setting Unit 105—

The simple flow velocity field setting unit 105 sets a simple flow velocity field in consideration of a boundary layer, a boundary layer peripheral flow, and a wake flow in the simulation space. The simple flow velocity field is input information for flow velocity field prediction AI.

Here, the velocity of fluid near the object decreases due to viscosity, and the boundary layer having a velocity equal to an inflow velocity is formed. As the object angle θ increases, the inflow energy increases, and thus the thickness of the boundary layer decreases. Furthermore, a momentum of fluid approaching the object is transported to an upper layer portion of the object, and the velocity of the upper layer portion increases. As the inflow velocity increases, inertia increases and thus diffusion decreases.

Furthermore, the fluid is dispersed in a vertical direction due to a pressure gradient behind the object. As the inflow velocity increases, inertia increases and thus the wake flow becomes long.

The simple flow velocity field is training data associating the boundary layer angle ψ (position of the boundary layer), the thickness l of velocity diffusion (diffusion range of fluid), and the wake flow angle φ (flow velocity diffusion range of a wake flow of fluid) with the flow velocity field by the Reynolds number Re (simulation condition).

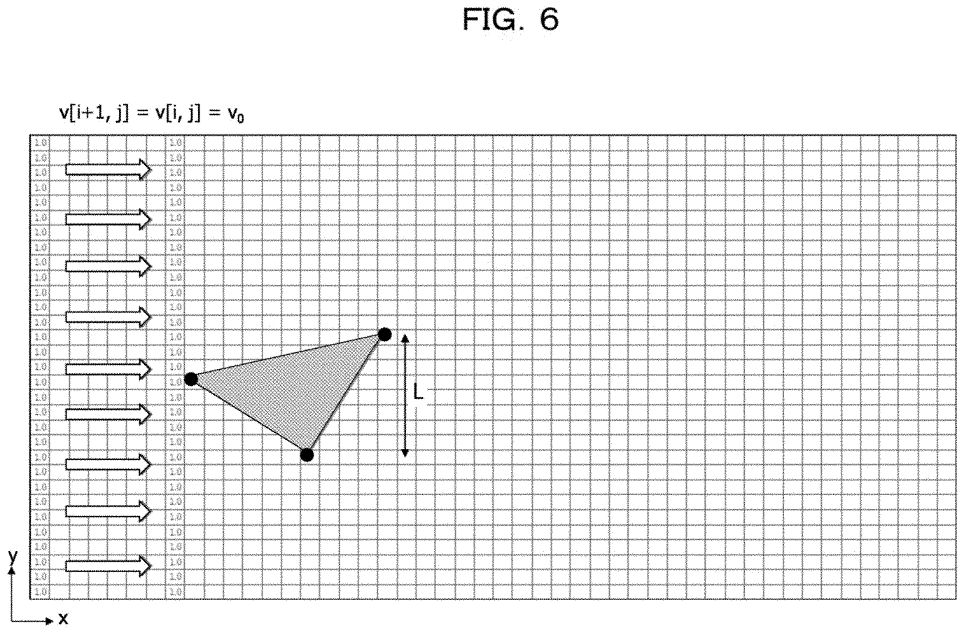

A method for setting the simple flow velocity field by the simple flow velocity field setting unit 105 will be described with reference to FIGS. 6 to 9.

The simple flow velocity field setting unit 105 virtually arranges the object in the simulation space based on the respective coordinate values of the front end, the upper end, and the lower end of the object acquired by the data group acquisition unit 101.

In the example illustrated in FIG. 6, the object having the front end P0, the upper end Pt, and the lower end Pb is arranged in the simulation space. The simulation space illustrated in FIG. 6 is divided into squares by a plurality of rectangular regions having the same size and the same shape. Hereinafter, an individual rectangular region set by partitioning the simulation space may be referred to as a unit region. The unit region may be called a cell.

The simple flow velocity field setting unit 105 sets the flow velocity field by setting the velocity (flow velocity) of fluid with respect to each of these individual unit regions. The value of flow velocity set in each of the individual unit regions may be referred to as a velocity value or a flow velocity value. For example, the flow velocity value of coordinates (i, j) in the simulation space is expressed as v[i, j].

The simple flow velocity field setting unit 105 performs setting for causing an inflow of fluid at a uniform velocity v0 from a boundary (left-side boundary) at the end of a left side of the screen (negative direction along the x-axis) in the simulation space.

The simple flow velocity field setting unit 105 first sets, in the simulation space, the flow velocity field for a region from the left-side boundary in the x-axis direction to the front end P0 of the object. The simple flow velocity field setting unit 105 sets an inflow velocity v0 (v0=1.0 in the example illustrated in FIG. 6) in each unit region over the entire region in the y-axis direction in the region from the left-side boundary in the x-axis direction to the front end P0 of the object.

For example, when the velocity v of the unit region represented by coordinates [i, j] in the simulation space is represented by v[i, j], the simple flow velocity field setting unit 105 assumes the velocity v of the unit area as v[i+1, j]=v[i, j]=v0 with respect to a section from the left-side boundary to the front end P0 of the object. This represents that in the simulation space, the velocity value v (=v0) of the unit region adjacent to the left is set in each unit region in order from the left-side boundary toward the right side.

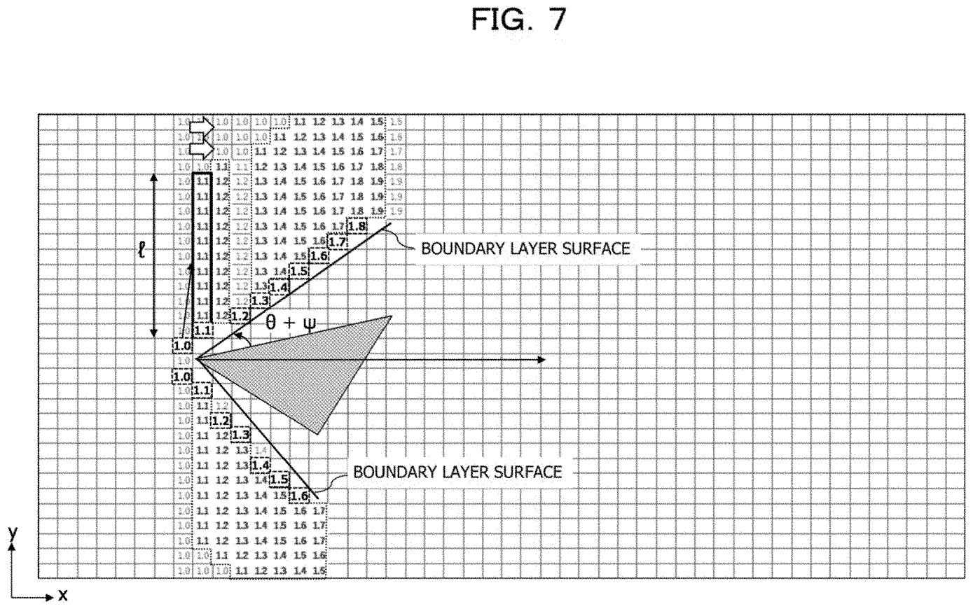

Next, as illustrated in FIG. 7, the simple flow velocity field setting unit 105 sets the flow velocity field with respect to regions outside (upper and lower sides) of the boundary layer surface with respect to the object.

The simple flow velocity field setting unit 105 estimates the boundary layer angle ψ using a model of the boundary layer angle ψ generated by the boundary layer angle estimation unit 102, the object angle θ, and the Reynolds number Re.

Furthermore, the thickness l of velocity diffusion is estimated by using a model of the thickness l of diffusion generated by the simple flow velocity field setting unit 105, the object angle θ, and the Reynolds number Re.

Then, the simple flow velocity field setting unit 105 distributes the flow velocity value to each unit region outside the boundary layer surface in the simulation space.

For example, when there is a boundary layer in the i+1 cell in an upper layer of the boundary layer surface in the simulation space, the simple flow velocity field setting unit 105 equally distributes the velocity value v[i, j] into v[i+1, j+1] to v[i+1, j+1+l]. Note that such distribution of velocity value may be achieved by a known method, and the description thereof will be omitted.

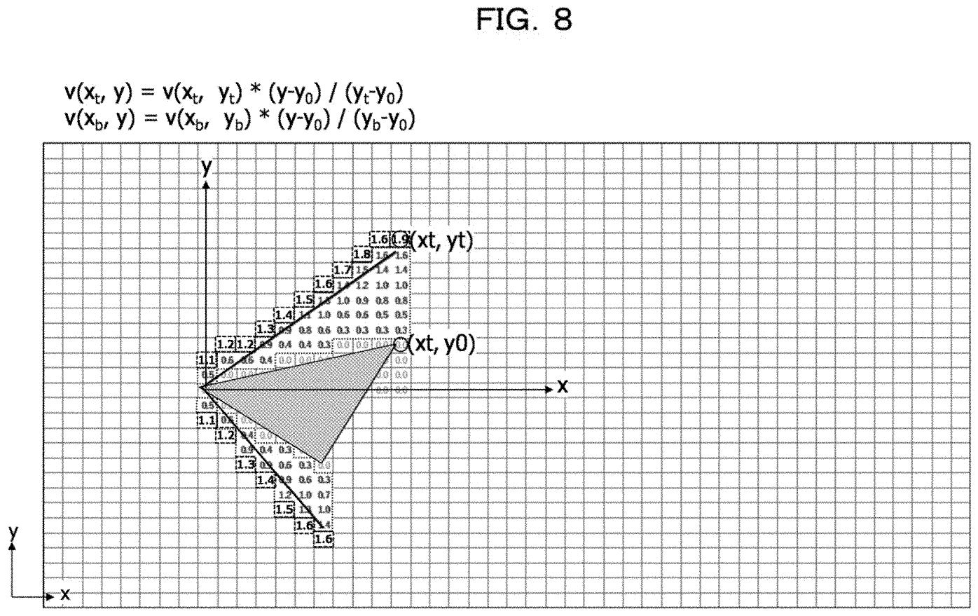

Furthermore, as illustrated in FIG. 8, the simple flow velocity field setting unit 105 uses the value v[i, j] on the boundary layer surface to set the velocity value of each unit region in the boundary layer by linear interpolation so that the velocity value on the object becomes zero.

For example, the simple flow velocity field setting unit 105 uses equation (11) below to set the velocity value of each unit region in the boundary layer formed between an upper side of the object and the boundary layer surface above the object in the simulation space.

v(xt,y)=v(xt,yt)*(y−y0)/(yt−y0) (11)

Furthermore, the simple flow velocity field setting unit 105 uses equation (12) below to set the velocity value of each unit region in the boundary layer formed between a lower side of the object and the boundary layer surface below the object in the simulation space.

v(xb,y)=v(xb,yb)*(y−y0)/(yb−y0) (12)

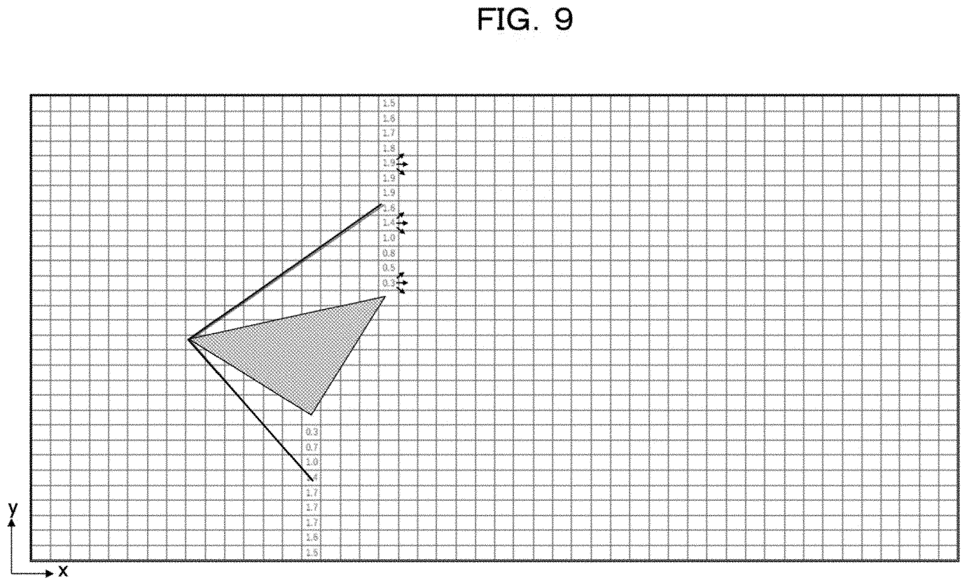

Thereafter, the simple flow velocity field setting unit 105 estimates the wake flow angle φ as illustrated in FIG. 9. The simple flow velocity field setting unit 105 estimates the wake flow angle φ based on a model of the wake flow angle φ generated by the wake flow angle estimation unit 104 and the Reynolds number Re. Then, the simple flow velocity field setting unit 105 completes the simple flow velocity field by distributing the velocity values with the angle φ to the cell of i+1.

Thus, the simple flow velocity field setting unit 105 estimates a flow velocity field corresponding to the simulation conditions that have been acquired by inputting the boundary layer, the diffusion range of the fluid, and the flow velocity diffusion range of the wake flow of the fluid that have been identified into a flow velocity field estimation model generated by using the training data associating the position of the boundary layer, the diffusion range of the fluid, and the flow velocity diffusion range of the wake flow of the fluid with a flow velocity field.

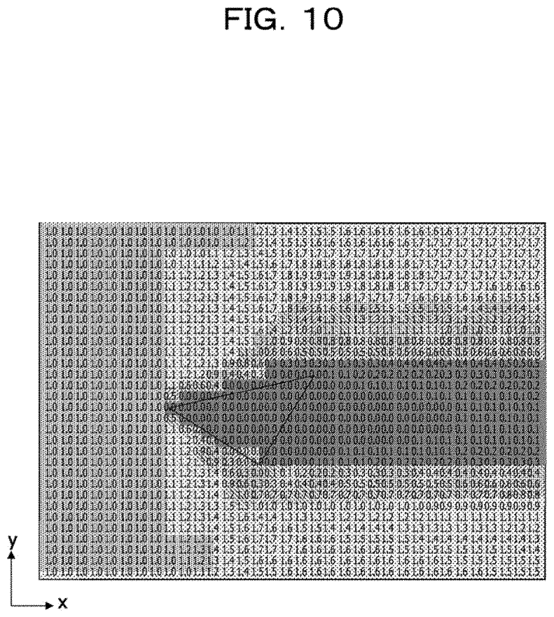

FIG. 10 is a diagram illustrating the simple flow velocity field in the simulation apparatus 1 as one example of the embodiment.

In the simple flow velocity field illustrated in FIG. 10, shading is set according to the velocity value of each cell for each cell constituting the simulation space. In the example illustrated in FIG. 10, the higher the velocity value, the lighter the color is set so that the state of the flow velocity field can be easily visually recognized.

—Learning Processing Unit 106—

The learning processing unit 106 constructs a learning model by deep learning (AI) with a simple flow velocity field as input and the flow velocity field of a simulation result as output.

The learning processing unit 106 acquires a data group (teacher data group) that is a data group for performing the aerodynamic simulation and is used for creating the learning model. Then, the learning processing unit 106 acquires, for example, respective coordinates of the front end, the upper end, and the lower end of the object in the simulation space from this data group.

The learning processing unit 106 estimates the boundary layer angle ψ using the model of the boundary layer angle ψ generated by the boundary layer angle estimation unit 102 based on the acquired data group.

Furthermore, the learning processing unit 106 estimates the thickness l of diffusion using a model of the thickness l of diffusion generated by the diffusion thickness estimation unit 103 based on the acquired data group.

The learning processing unit 106 estimates the wake flow angle φ using the model of the wake flow angle φ generated by the wake flow angle estimation unit 104 based on the acquired data group.

Then, the learning processing unit 106 uses the respective coordinates of the front end, the upper end, and the lower end, the boundary layer angle ψ, the thickness l of diffusion, and the wake flow angle φ of the object to create a simple flow velocity field corresponding to the acquired data group. To create the simple flow velocity field, a similar process to the process by the simple flow velocity field setting unit 105 described above may be executed.

The learning processing unit 106 constructs, by the deep learning (AI), the learning model with the created simple flow velocity field as input and the flow velocity field of the simulation result as output.

Note that the construction of the learning model using this simple flow velocity field as input and the flow velocity field of the simulation result as output can be achieved by using a known method, and the detailed description thereof will be omitted.

—Evaluation Unit 107—

The evaluation unit 107 evaluates the learning model constructed by the learning processing unit 106, and verifies, for example, whether it is in an overlearning state, or the like.

The evaluation unit 107 acquires a data group (evaluation data group) that is a data group for performing the aerodynamic simulation and is used for evaluating the learning model. As the evaluation data group, data different from the teacher data group used by the learning processing unit 106 is used.

From this data group, the learning processing unit 106 acquires, for example, respective coordinates of the front end, the upper end, and the lower end of the object in the simulation space.

The evaluation unit 107 estimates the boundary layer angle ψ using the model of the boundary layer angle ψ generated by the boundary layer angle estimation unit 102 based on the acquired data group.

Furthermore, the evaluation unit 107 estimates the thickness l of diffusion using a model of the thickness l of diffusion generated by the diffusion thickness estimation unit 103 based on the acquired data group.

The evaluation unit 107 estimates a wake flow angle φ using the model of the wake flow angle φ generated by the wake flow angle estimation unit 104 based on the acquired data group.

Then, the evaluation unit 107 uses the respective coordinates of the front end, the upper end, and the lower end, the boundary layer angle ψ, the thickness l of diffusion, and the wake flow angle φ of the object to create a simple flow velocity field corresponding to the acquired data group. To create the simple flow velocity field, a similar process to the process by the simple flow velocity field setting unit 105 described above may be executed.

The evaluation unit 107 inputs the created simple flow velocity field into the learning model created by the learning processing unit 106, and acquires the flow velocity field (prediction result) of the simulation result.

The evaluation unit 107 evaluates accuracy of a prediction result output based on the evaluation data group. For example, the evaluation unit 107 may determine whether the difference between accuracy of a prediction result output based on the evaluation data group and accuracy of a prediction result output based on the teacher data group is within a permissible threshold. For example, the evaluation unit 107 may determine whether the accuracy of a prediction result output based on the evaluation data group and the accuracy of a prediction result output based on the teacher data group are at the same level of accuracy.

(B) Operation

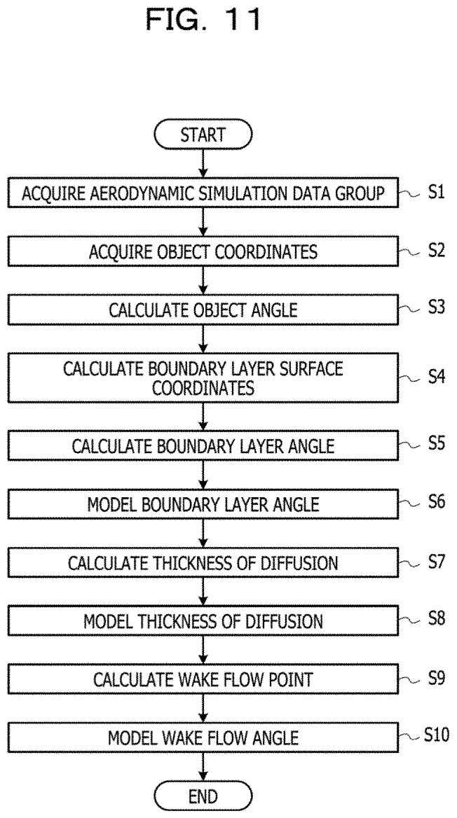

A model construction process of the simple flow velocity field in the simulation apparatus 1 as one example of the embodiment configured as described above will be described with reference to a flowchart (steps S1 to S10) illustrated in FIG. 11.

In step S1, the data group acquisition unit 101 acquires an aerodynamic simulation data group for performing the aerodynamic simulation.

In step S2, the data group acquisition unit 101 acquires respective coordinates of the front end P0, the upper end Pt, and the lower end Pb of the object.

The boundary layer angle estimation unit 102 calculates the object angle θ of the object (step S3), calculates the boundary layer surface coordinates for the object (step S4), and calculates the boundary layer angle ψ (step S5). Then, in step S6, the boundary layer angle estimation unit 102 constructs (models) a model for estimating the boundary layer angle ψ.

In step S7, the diffusion thickness estimation unit 103 calculates y-coordinate values of the thickness upper end Plt and the thickness lower end, for example, the thickness l of diffusion. Furthermore, in step S8, the boundary layer angle estimation unit 102 constructs (models) a model for estimating the thickness l of diffusion.

In step S9, the wake flow angle estimation unit 104 calculates the coordinates of the wake flow point of the object in the simulation space. Furthermore, in step S10, the wake flow angle estimation unit 104 constructs (models) a model for estimating the wake flow angle φ. Thereafter, the process ends.

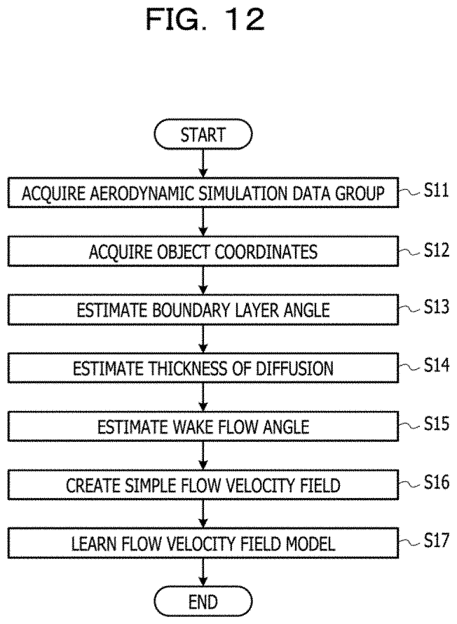

Next, a process of creating the learning model by the learning processing unit 106 in the simulation apparatus 1 as one example of the embodiment will be described with reference to a flowchart (steps S11 to S17) illustrated in FIG. 12.

In step S11, the learning processing unit 106 acquires a data group (teacher data group) that is a data group for performing the aerodynamic simulation and is used for creating the learning model.

In step S12, the learning processing unit 106 acquires respective coordinates of the front end, the upper end, and the lower end of the object in the simulation space from the data group.

In step S13, the learning processing unit 106 estimates the boundary layer angle ψ using the model of the boundary layer angle ψ generated by the boundary layer angle estimation unit 102 in step S6 of FIG. 11 described above based on the acquired data group.

In step S14, the learning processing unit 106 estimates the thickness l of diffusion using the model of the thickness l of diffusion generated by the diffusion thickness estimation unit 103 in step S8 of FIG. 11 described above based on the acquired data group.

In step S15, the learning processing unit 106 estimates the wake flow angle φ using the model of the wake flow angle φ generated by the wake flow angle estimation unit 104 in step S10 of FIG. 11 described above based on the acquired data group.

In step S16, the learning processing unit 106 creates a simple flow velocity field corresponding to the acquired data group using the respective coordinates of the front end, the upper end, and the lower end, the boundary layer angle ψ, the thickness l of diffusion, and the wake flow angle φ of the object.

In step S17, the learning processing unit 106 constructs a learning model with the created simple flow velocity field as input and the flow velocity field of the simulation result as output by the deep learning (AI). Thereafter, the process ends.

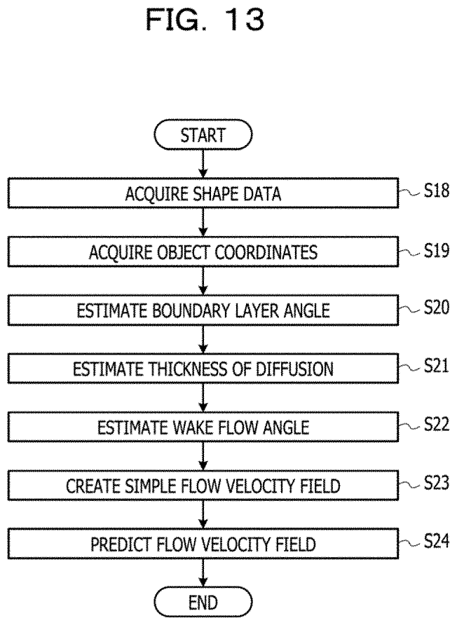

Next, a verification process of the learning model by the evaluation unit 107 in the simulation apparatus 1 as one example of the embodiment will be described with reference to a flowchart (steps S18 to S24) illustrated in FIG. 13.

In step S18, the evaluation unit 107 acquires a data group (evaluation data group) that is a data group for performing the aerodynamic simulation and is used for evaluation of the learning model. The data group also includes shape data of the object. Thus, the evaluation unit 107 acquires the shape data of the object.

In step S19, the evaluation unit 107 acquires respective coordinates of the front end, the upper end, and the lower end of the object in the simulation space from the data group.

In step S20, the evaluation unit 107 estimates the boundary layer angle ψ using the model of the boundary layer angle ψ generated by the boundary layer angle estimation unit 102 in step S6 of FIG. 11 described above based on the acquired data group.

In step S21, the evaluation unit 107 estimates the thickness l of diffusion using the model of the thickness l of diffusion generated by the diffusion thickness estimation unit 103 in step S8 of FIG. 11 described above based on the acquired data group.

In step S22, the evaluation unit 107 estimates the wake flow angle φ using the model of the wake flow angle φ generated by the wake flow angle estimation unit 104 in step S10 of FIG. 11 described above based on the acquired data group.

In step S23, the evaluation unit 107 creates a simple flow velocity field corresponding to the acquired data group using the respective coordinates of the front end, the upper end, and the lower end, the boundary layer angle ψ, the thickness l of diffusion, and the wake flow angle φ of the object.

In step S24, the evaluation unit 107 inputs the created simple flow velocity field into the learning model created by the learning processing unit 106, and acquires the flow velocity field (prediction result) of the simulation result. Then, the evaluation unit 107 evaluates accuracy of the prediction result output based on the evaluation data group. Thereafter, the process ends.

(C) Effects

As described above, by the simulation apparatus 1 as one example of the embodiment, a simple flow velocity field based on the object angle θ and the Reynolds number Re of the object is created, and this simple flow velocity field is used as input data for machine learning. Thus, it is possible to estimate a robust flow velocity field with respect to unknown input data. For example, prediction accuracy may be improved and overfitting may be suppressed.

By reflecting the object angle θ of the object on the simple flow velocity field, flow velocity field characteristics for every shape of the object are reflected on the input data for machine learning. Thus, it is possible to estimate the flow velocity field according to the shape of the object on the upstream side.

By estimating the flow velocity field by AI using the learning model, there is no need to repeatedly execute simulation calculations using aerodynamic simulation data, and trial production of virtual design in an ultra-upstream process may be achieved at low cost.

For example, while the conventional aerodynamic analysis method takes several days for simulating a plurality of cases, the simulation apparatus 1 may achieve estimation of the flow velocity field in a calculation time of several minutes. Thus, it is possible to execute evaluation of a large number of prototypes in a short time, and a short-term and comprehensive virtual design may be implemented.

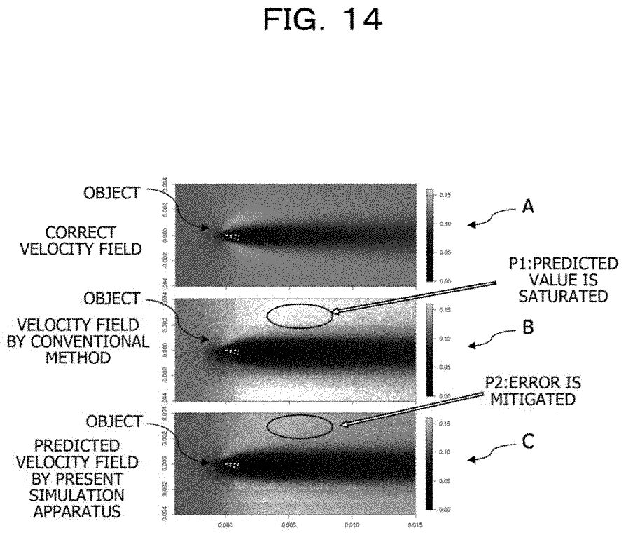

FIG. 14 is a diagram illustrating a predicted flow velocity field by the simulation apparatus 1 as one example of the embodiment together with a correct flow velocity field and a predicted flow velocity field by the conventional aerodynamic analysis method.

In FIG. 14, a reference sign A indicates a correct flow velocity field, a reference sign B indicates a predicted flow velocity field by the conventional aerodynamic analysis method, and a reference sign C indicates the predicted flow velocity field by the simulation apparatus 1.

FIG. 14 illustrates an example in which models constructed by the respective techniques are applied to object data different from learning data. Two types of Reynolds numbers (Re=5, Re=50)×126 different object shapes (shape angle, length) are used as learning data. Furthermore, as evaluation data, eight types of Reynolds numbers (Re=0.01 to 40)×26 different object shapes (shape angles, lengths) are used.

Compared to the correct flow velocity field, the predicted flow velocity field by the conventional aerodynamic analysis method is in a state where, for example, the predicted value is saturated in a region indicated by a reference sign P1. For example, it is not possible to reflect dependency on changes in the Reynolds number Re and the object shape on the input data.

On the other hand, at the same location in the predicted flow velocity field by the present simulation apparatus 1, an error of the predicted value is mitigated as compared with the predicted flow velocity field by the conventional aerodynamic analysis method (see the reference sign P2). For example, the simulation apparatus 1 adapts itself to the unknown Reynolds number Re, and generalization performance is improved.

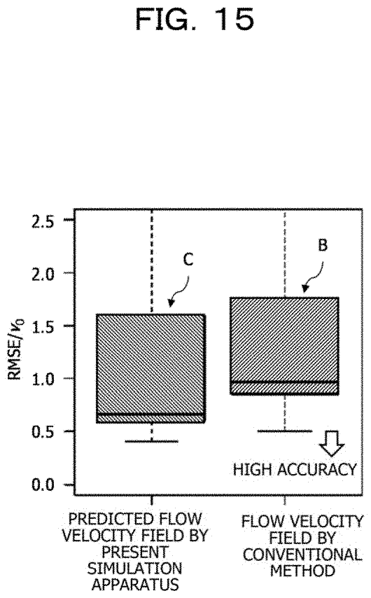

FIG. 15 is a diagram for comparing accuracy evaluation indexes of the predicted flow velocity field by the simulation apparatus 1 as one example of the embodiment and the predicted flow velocity field by the conventional aerodynamic analysis method.

FIG. 15 illustrates root mean squared errors (RMSE) of the predicted flow velocity field by the simulation apparatus 1 illustrated in FIG. 14 and the predicted flow velocity field by the conventional aerodynamic analysis method. As illustrated in FIG. 15, it may be seen that the predicted flow velocity field by the simulation apparatus 1 has significantly smaller errors (risk rate 5%) and higher accuracy than the predicted flow velocity field by the conventional aerodynamic analysis method.

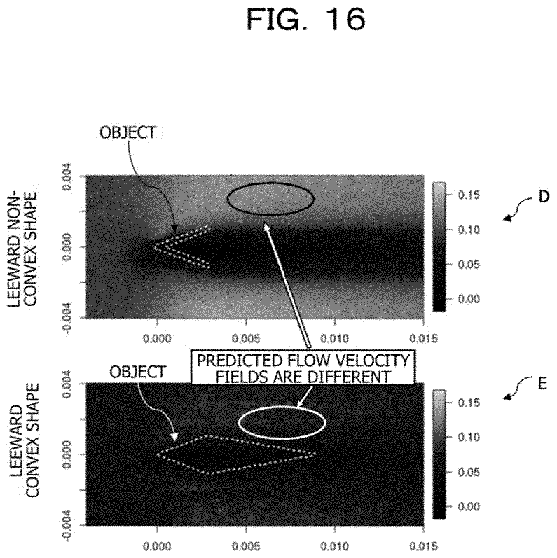

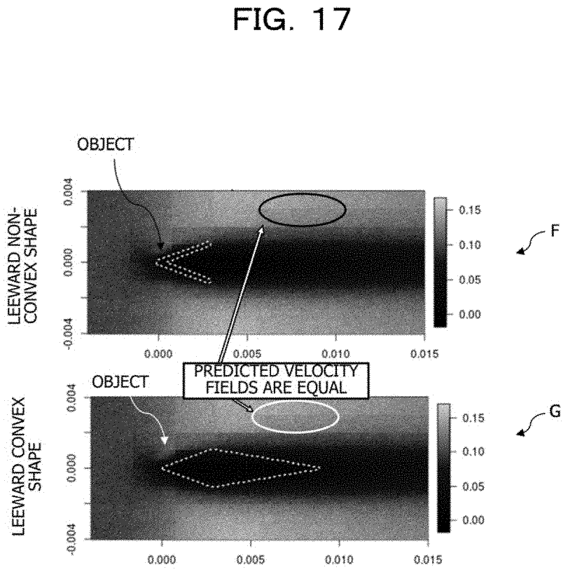

FIGS. 16 and 17 are diagrams for explaining a difference in predicted flow velocity fields for objects having different shapes on the leeward side between the conventional aerodynamic analysis method and the present simulation apparatus 1.

FIG. 16 illustrates a predicted flow velocity field for a leeward non-convex shape object and a predicted flow velocity field for a leeward convex shape object by the conventional aerodynamic analysis method. FIG. 17 illustrates a predicted flow velocity field for a leeward non-convex shape object and a predicted flow velocity field for a leeward convex shape object by the simulation apparatus 1.

Between objects with similar shapes on the windward side, the flow velocity fields are supposed to be equal even when the shapes on the leeward side are different.

However, as illustrated in FIG. 16, in the predicted flow velocity fields by the conventional aerodynamic analysis method, when the shapes on the leeward side are different, the predicted flow velocity fields excessively react to such changes in the object shape, estimation accuracy of the predicted flow velocity fields deteriorates, and a difference occurs in the predicted flow velocity fields.

In this simulation apparatus 1, as illustrated in FIG. 17, the predicted flow velocity fields are equal even when the shapes on the leeward side are different. For example, the learning is performed so that similar predicted flow velocity fields may be output between objects having similar shapes on the windward side and different shapes on the leeward side from each other. By learning the effects of the leeward shape in consideration of behaviors of the fluid on the windward side and the leeward side with respect to the object, the simulation apparatus 1 adapts itself to unknown shapes, and generalization performance is improved.

(D) Others

FIG. 18 is a diagram illustrating a hardware configuration of the simulation apparatus 1 as one example of the embodiment.

The simulation apparatus 1 is an information processing apparatus (computer) and has, for example, a processor 11, a memory 12, a storage device 13, a graphic processing device 14, an input interface 15, an optical drive device 16, a device connection interface 17, and a network interface 18 as components. These components 11 to 18 are configured to be able to communicate with each other via a bus 19.

The processor (processing unit) 11 controls the entire simulation apparatus 1. The processor 11 may be a multiprocessor. The processor 11 may be, for example, any one of a central processing unit (CPU), a micro processing unit (MPU), a digital signal processor (DSP), an application specific integrated circuit (ASIC), a programmable logic device (PLD), and a field programmable gate array (FPGA). Furthermore, the processor 11 may be a combination of two or more types of elements of the CPU, MPU, DSP, ASIC, PLD, and FPGA.

Then, the processor 11 executes a control program (a machine learning program and a flow velocity field estimation program, which are not illustrated) for the simulation apparatus 1, thereby implementing functions as the data group acquisition unit 101, the boundary layer angle estimation unit 102, the diffusion thickness estimation unit 103, the wake flow angle estimation unit 104, the simple flow velocity field setting unit 105, the learning processing unit 106, and the evaluation unit 107 illustrated in FIG. 1. Thus, the simulation apparatus 1 functions as a machine learning device and a data generation device.

Note that the simulation apparatus 1 executes, for example, a program (a machine learning program, a flow velocity field estimation program, and an OS program) recorded on a computer-readable non-temporary recording medium, thereby implementing functions as the data group acquisition unit 101, the boundary layer angle estimation unit 102, the diffusion thickness estimation unit 103, the wake flow angle estimation unit 104, the simple flow velocity field setting unit 105, the learning processing unit 106, and the evaluation unit 107.

A program in which contents of processes to be executed by the simulation apparatus 1 are described may be recorded in various recording media. For example, a program to be executed by the simulation apparatus 1 may be stored in the storage device 13. The processor 11 loads at least a part of the program in the storage device 13 on the memory 12 and executes the loaded program.

Furthermore, the program to be executed by the simulation apparatus 1 (processor 11) may be recorded on a non-transitory portable recording medium such as an optical disk 16a, a memory device 17a, and a memory card 17c. The program stored in the portable recording medium may be executed after being installed in the storage device 13, for example, by control from the processor 11. Furthermore, the processor 11 may directly read and execute the program from the portable recording medium.

The memory 12 is a storage memory including a read only memory (ROM) and a random access memory (RAM). The RAM of the memory 12 is used as the main storage device of the simulation apparatus 1. The RAM temporarily stores at least a part of programs to be executed by the processor 11. Furthermore, the memory 12 stores various data needed for the processing by the processor 11.

The storage device 13 is a storage device such as a hard disk drive (HDD), a solid state drive (SSD), or a storage class memory (SCM), and stores various data. The storage device 13 is used as an auxiliary storage device for the simulation apparatus 1. The storage device 13 stores an OS program, a control program, and various data. The control program includes the machine learning program or the flow velocity field estimation program.

Note that a semiconductor storage device such as an SCM or a flash memory may be used as the auxiliary storage device. Furthermore, redundant arrays of inexpensive disks (RAID) may be formed by using a plurality of storage devices 13.

Furthermore, the storage device 13 may store various data generated when the data group acquisition unit 101, the boundary layer angle estimation unit 102, the diffusion thickness estimation unit 103, the wake flow angle estimation unit 104, the simple flow velocity field setting unit 105, the learning processing unit 106, and the evaluation unit 107 described above execute respective processes.

For example, a data group acquired by the data group acquisition unit 101 may be stored in the storage device 13. Furthermore, the storage device 13 may store the boundary layer angle ψ calculated by the boundary layer angle estimation unit 102 and an upper part of the equation representing the constructed model.

Furthermore, the thickness l of velocity diffusion and the upper part of the equation representing the model which are calculated and constructed by the diffusion thickness estimation unit 103 may be stored in the storage device 13, and the wake flow angle φ calculated by the wake flow angle estimation unit 104 and an upper part of the equation representing the model constructed by the wake flow angle estimation unit 104 may be stored in the storage device 13. Moreover, the information of the simple flow velocity field set by the simple flow velocity field setting unit 105 may be stored in the storage device 13.

The graphic processing device 14 is connected to the monitor 14a. The graphic processing device 14 displays an image on a screen of the monitor 14a according to a command from the processor 11. Examples of the monitor 14a include a display device using a cathode ray tube (CRT), a liquid crystal display device, or the like.

The input interface 15 is connected to the keyboard 15a and the mouse 15b. The input interface 15 transmits signals sent from the keyboard 15a and the mouse 15b to the processor 11. Note that the mouse 15b is one example of a pointing device, and another pointing device may also be used. Examples of the another pointing device include a touch panel, a tablet, a touch pad, a track ball, or the like.

The optical drive device 16 reads data recorded on the optical disk 16a using laser light or the like. The optical disk 16a is a non-transitory portable recording medium having data recorded in a readable manner by reflection of light. Examples of the optical disk 16a include a digital versatile disc (DVD), a DVD-RAM, a compact disc read only memory (CD-ROM), a CD-recordable (R)/rewritable (RW), or the like.

The device connection interface 17 is a communication interface for connecting the peripheral devices to the simulation apparatus 1. For example, the device connection interface 17 may be connected to a memory device 17a and a memory reader/writer 17b. The memory device 17a is a non-transitory recording medium having a communication function with the device connection interface 17, and is, for example, a universal serial bus (USB) memory. The memory reader/writer 17b writes data to the memory card 17c or reads data from the memory card 17c. The memory card 17c is a card-type non-transitory recording medium.

The network interface 18 is connected to a network. The network interface 18 transmits and receives data via the network. Other information processing devices, communication devices, and the like may be connected to the network. For example, the network may be connected to a modeling system that models an object shape.

Then, the disclosed technology is not limited to the above-described embodiment, and various modifications may be made and implemented without departing from the scope of the present embodiment. Each of the configurations and each of the processes of the present embodiment may be selected or omitted as needed or may be appropriately combined.

For example, information of model accuracy may be presented regarding at least one of the model of the boundary layer angle ψ by the boundary layer angle estimation unit 102, the model of the thickness l of diffusion by the diffusion thickness estimation unit 103, or the model of the wake flow angle φ by the wake flow angle estimation unit 104 described above.

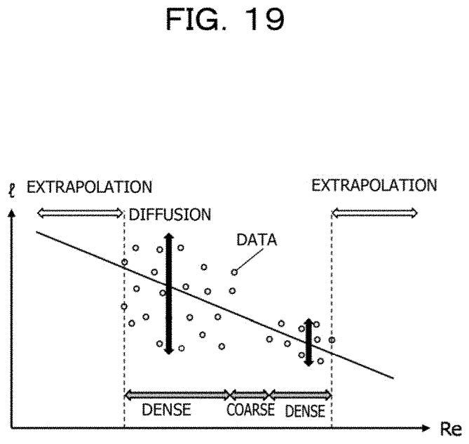

FIG. 19 is a diagram for explaining model accuracy regarding the model of the thickness l of diffusion.

In an example illustrated in FIG. 19, in a graph in which the horizontal axis is the Reynolds number Re and the vertical axis is the thickness l of velocity diffusion, the equation for the thickness l of diffusion is represented by a straight line that descends to the right, and simulation data is depicted as dots. In the model of the thickness l of velocity diffusion illustrated in FIG. 19, a region where data is absent may be presented as extrapolation. Furthermore, the range of variations (errors) of data may be presented as a distribution. Moreover, sparse and dense information representing a sparse range and a dense range of data may be presented.

In the above-described embodiment, the example has been described in which the fluid is gas (air) and the simulation apparatus 1 performs an aerodynamic simulation, but the embodiment is not limited to this. The fluid may be, for example, gas other than air or may be liquid, and may be variously changed to perform a simulation.

Furthermore, the present embodiment may be implemented and manufactured by those skilled in the art according to the above-described disclosure.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium for storing a machine-learning program which causes a processor to perform processing, the processing comprising:
acquiring simulation conditions including a shape of an object and an inflow velocity of fluid;
identifying, based on the shape of the object and the inflow velocity that have been acquired, a position of a boundary layer with respect to the object, a diffusion range of the fluid, and a flow velocity diffusion range of a wake flow of the fluid;
creating training data associating the position of the boundary layer, the diffusion range of the fluid, and the flow velocity diffusion range of the wake flow of the fluid that have been identified with a flow velocity field under the simulation conditions; and
generating a model configured to estimate the flow velocity field from the simulation conditions by using the training data.

2. The non-transitory computer-readable storage medium according to claim 1, wherein the position of the boundary layer includes, when a front end of the object on an upstream side in a flow direction of the fluid is assumed as an origin of a height, an angle formed by a straight line connecting the front end and a point where a flow velocity coincides with an initial velocity and by a reference axis along the flow direction.

3. The non-transitory computer-readable storage medium according to claim 2, wherein the diffusion range of the fluid includes, when the front end of the object on the upstream side in the flow direction of the fluid is assumed as the origin of the height, a height component at a position where the flow velocity is maximum, the height component being calculated based on a first angle and a Reynolds number, the first angle being an angle formed by a straight line connecting the front end and an end portion of the object adjacent to the front end and by the reference axis along the flow direction.

4. The non-transitory computer-readable storage medium according to claim 3, wherein the flow velocity diffusion range of the wake flow of the fluid includes, when the front end of the object on the upstream side in the flow direction of the fluid is assumed as the origin of the height, an angle formed by a straight line connecting the end portion of the object adjacent to the front end and a point where the flow velocity becomes zero on a downstream side of the object in the flow direction of the fluid and by the reference axis.

5. A machine learning device comprising:
a memory; and
a processor coupled to the memory, the processor being configured to perform processing, the processing including:
acquiring simulation conditions including a shape of an object and an inflow velocity of fluid;
identifying, based on the shape of the object and the inflow velocity that have been acquired, a position of a boundary layer with respect to the object, a diffusion range of the fluid, and a flow velocity diffusion range of a wake flow of the fluid;
creating training data associating the position of the boundary layer, the diffusion range of the fluid, and the flow velocity diffusion range of the wake flow of the fluid that have been identified with a flow velocity field under the simulation conditions; and
generating a model that estimates the flow velocity field from the simulation conditions by using the training data.

6. The machine learning device according to claim 5, wherein the position of the boundary layer includes, when a front end of the object on an upstream side in a flow direction of the fluid is assumed as an origin of a height, an angle formed by a straight line connecting the front end and a point where a flow velocity coincides with an initial velocity and by a reference axis along the flow direction.

7. The machine learning device according to claim 6, wherein the diffusion range of the fluid includes, when the front end of the object on the upstream side in the flow direction of the fluid is assumed as the origin of the height, a height component at a position where the flow velocity is maximum, the height component being calculated based on a first angle and a Reynolds number, the first angle being an angle formed by a straight line connecting the front end and an end portion of the object adjacent to the front end and by the reference axis along the flow direction.

8. The machine learning device according to claim 7, wherein the flow velocity diffusion range of the wake flow of the fluid includes, when the front end of the object on the upstream side in the flow direction of the fluid is assumed as the origin of the height, an angle formed by a straight line connecting the end portion of the object adjacent to the front end and a point where the flow velocity becomes zero on a downstream side of the object in the flow direction of the fluid and by the reference axis.

9. A machine learning method implemented by a computer, the method comprising:
acquiring simulation conditions including a shape of an object and an inflow velocity of fluid;
identifying, based on the shape of the object and the inflow velocity that have been acquired, a position of a boundary layer with respect to the object, a diffusion range of the fluid, and a flow velocity diffusion range of a wake flow of the fluid;
creating training data associating the position of the boundary layer, the diffusion range of the fluid, and the flow velocity diffusion range of the wake flow of the fluid that have been identified with a flow velocity field under the simulation conditions; and
generating a model that estimates the flow velocity field from the simulation conditions by using the training data.

10. A non-transitory computer-readable storage medium for storing a flow velocity field estimation program which causes a processor to perform processing, the processing comprising:
acquiring simulation conditions including a shape of an object and an inflow velocity of fluid;
identifying, based on the shape of the object and the inflow velocity that have been acquired, a position of a boundary layer with respect to the object, a diffusion range of the fluid, and a flow velocity diffusion range of a wake flow of the fluid; and
estimating a flow velocity field corresponding to the simulation conditions that have been acquired by inputting the boundary layer, the diffusion range of the fluid, and the flow velocity diffusion range of the wake flow of the fluid that have been identified into a flow velocity field estimation model generated by using training data associating the position of the boundary layer, the diffusion range of the fluid, and the flow velocity diffusion range of the wake flow of the fluid with the flow velocity field.

11. The non-transitory computer-readable storage medium according to claim 10, wherein the position of the boundary layer includes, when a front end of the object on an upstream side in a flow direction of the fluid is assumed as an origin of a height, an angle formed by a straight line connecting the front end and a point where a flow velocity coincides with an initial velocity and by a reference axis along the flow direction.

12. The non-transitory computer-readable storage medium according to claim 11, wherein the diffusion range of the fluid includes, when the front end of the object on the upstream side in the flow direction of the fluid is assumed as the origin of the height, a height component at a position where the flow velocity is maximum, the height component being calculated based on a first angle and a Reynolds number, the first angle being an angle formed by a straight line connecting the front end and an end portion of the object adjacent to the front end and by the reference axis along the flow direction.

13. The non-transitory computer-readable storage medium according to claim 12, wherein the flow velocity diffusion range of the wake flow of the fluid includes, when the front end of the object on the upstream side in the flow direction of the fluid is assumed as the origin of the height, an angle formed by a straight line connecting the end portion of the object adjacent to the front end and a point where the flow velocity becomes zero on a downstream side of the object in the flow direction of the fluid and by the reference axis.
